(19) United States
(12) Patent Application Publication
(10) Pub. No.: US 2023/0314297 A1
(43) Pub. Date: Oct. 5, 2023

(54) SORTING OF CELLULAR BODIES BASED ON FORCE SPECTROSCOPY

(71) Applicant: LUMICKS CA HOLDING B.V., Amsterdam (NL)

(72) Inventors: Rogier Martijn Reijmers, Amsterdam (NL); Gerrit Sitters, Amsterdam (NL)

(21) Appl. No.: 18/023,292

(22) PCT Filed: Sep. 1, 2021
(86) PCT No.: PCT/NL2021/050533

§ 371 Date: Feb. 24, 2023

(30) Foreign Application Priority Data
Sep. 1, 2020 (NL) 2026393

(51) Int. Cl. G01N 15/14

(52) U.S. Cl. CPC G01N 15/14; G01N 2015/149

(57) ABSTRACT

A method of sorting cellular bodies comprises receiving images representing manipulation of first cellular bodies in a holding space of a flow cell including or connected to a sorting device, the manipulation including: allowing some of the first cellular bodies to contact a functionalized wall of the holding space; applying a force to the contacted first cellular bodies for detaching some of the first cellular bodies; and, transporting the cellular bodies to the sorting device; and, processing the sequence of images of the first cellular bodies and controlling the sorting device based on the image processing by detecting detachments of first cellular bodies in the images; determining for each detected detached first cell a detachment force; tracking the location of detached first cellular bodies during the transport of the cellular bodies to the sorting device; and, sorting the cellular bodies by controlling the sorting device based on the detachment force.

### FIELD OF THE INVENTION

The disclosure relates to sorting of cellular bodies based on force spectroscopy and, in particular, though not exclusively, to methods and systems for single cell sorting based on force spectroscopy, and a computer program product enabling a computer system to perform such methods.

### BACKGROUND OF THE INVENTION

The study of interactions between cellular bodies and cellular bodies and other molecules, e.g. the binding strength of cells on cells and cells on proteins, is a highly relevant and active research area in biosciences. For example, the avidity characterizes the cumulative effect of multiple individual binding interactions between cells. Similarly, the affinity characterizes the strength with which a cell, e.g. an antibody, binds to a protein complex that is part of a cell membrane of a target cell. The avidity and affinity are examples of parameters that play an essential role in the study and development of therapies in medicine, e.g. immune oncology.

A technique for studying interactions between cells or between cellular bodies and any ligands is referred to as force spectroscopy. For example, WO2018/083193 describes a so-called acoustic force spectroscopy (AFS) system that is configured to examine interactions between cells by applying a force to the cells. The system includes a microfluidic cell comprising a functionalised wall surface which may include target cells.

A plurality of effector cells, e.g. T-cells, can be flushed into the microfluidic cell, so that they can settle and bind to target cells. Thereafter, an acoustic source is used to exert a ramping force on the bound effector cells so that effector cells will detach from the target cells at a certain force. During this process, the spatiotemporal behaviour of the effector cells in the microfluidic cells is imaged using an imaging microscope. The interaction strength between cells, e.g. the force at which the effector cells detach, may be determined by analysing the captured video images during the ramping force. For example, the cell avidity of the effector cells can be determined this way.

WO2018/083193 suggests that the described force spectroscopy scheme can also be used for sorting cells. For example, a force ramp could be applied up to a certain value and all cells that detach during this force ramp may be flushed away and separated from the cells that did not detach. A shortcoming of this scheme is it only allows a very coarse way of sorting or separating groups of cells into sub-groups. It does not allow sorting of cells based on the detachment force of individual cells. Additionally, the scheme does not allow sorting of cells based on additional parameters, e.g. optical properties of cells.

Schemes for sorting individual cells are known in the art. For example, flow cytometry is a technique wherein a fluidic system is used to guide cells through a focusing region so that a stream of single cells is formed. An example of such microfluidic system is described in the article by Choi et al, Microfluidic deformability-activated sorting of single particles, Microsystems & Nanoengineering, 6, article number: 11 (2020). Individual cells are pushed through a narrow nozzle, which may be regarded as an interrogation point, at which the deformability of the cell may be measured. Based on a measured response, a sorting action is triggered by switching a sorting valve downstream of the interrogation point to send the cell to a specific receiving reservoir.

Although single cell sorting is achieved, such schemes are limited in the sense that sorting is based on the deformability of a cell and not on information how cells interact with other cells or proteins, i.e. information that is essential for study and development of therapies in medicine. Moreover, the sorting scheme requires a measurement at the interrogation point, which may inhibit fast sorting schemes, which are desirable for high throughout sorting schemes.

Hence, from the above, it follows that there is a need in the art for improved cell sorting based on force spectroscopy. In particular, there is a need in the art for cell sorting system that allow single cell sorting based a cell interaction force and, optionally, other individual cell parameters.

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non- exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including a functional or an object oriented programming language such as Java(TM), Scala, C++, Python or the like and conventional procedural programming languages, such as the “C” programming language or similar programming languages. The program code may execute entirely on the user’s computer, partly on the user’s computer, as a stand-alone software package, partly on the user’s computer and partly on a remote computer, or entirely on the remote computer, server or virtualized server. In the latter scenario, the remote computer may be connected to the user’s computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), or graphics processing unit (GPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is an objective of the embodiments in this disclosure to reduce or eliminate at least one of the drawbacks known in the prior art.

The main insight of the embodiments in this disclosure revolves around sorting of single cellular bodies based on interaction information, i.e. information about an interaction or interactions, such as a binding force, of a single cellular body with another cellular body or a single cellular body with one or more proteins or other ligands. Force spectroscopy on a large ensemble of cellular bodies may be used to efficiently obtain specific interaction information for each of the cellular bodies (or at least a large part of the cellular bodies) a single cell shorting device may be controlled to sort the cellular bodies based on the interaction information.

The terms cellular bodies referred to in this application may include cell portions like subcellular organelles, cell nuclei, and/or mitochondria. The cellular bodies may be unicellular or pluricellular, such as small clumped cell groups, plant or animal biopts, dividing cells, budding yeast cells, colonial protists, etc. The cellular bodies may also be animal embryos in an early stage of development (e.g. the morula-stadium of a mammal, possibly a human embryo). In particular cases different types of cellular bodies may be studied together. E.g., cellular bodies from a mucosal swab, blood sample, or other probing techniques could be used. A cellular body may also be one or more immune cells, one or more tumor cells, one or more cells that have been infected, for example by a virus.

In an aspect, the invention relates to a method of sorting cellular bodies comprising: receiving images representing manipulation of first cellular bodies in a holding space of a flow cell, the flow cell including or being connected to a sorting device, the manipulation including: providing the first cellular bodies in the holding space to allow at least part of the first cellular bodies to contact a functionalized wall of the holding space; applying a force to the contacted first cellular bodies in a direction away from the functionalized wall for detaching at least part of the first cellular bodies; and, transporting the detached cellular bodies to the sorting device for individually sorting the detached cellular bodies; processing the sequence of images during the manipulation of the first cellular bodies and controlling the sorting device based on the image processing, the processing and controlling including: detecting detachments of first cellular bodies in the images during the application of the force; determining for each detected detached first cellular bodies a detachment force; tracking the location of detected detached first cellular bodies during the transport of the detached cellular bodies to the sorting device; and, sorting the detached cellular bodies by controlling the sorting device based on the detachment force.

Hence, a large set of cellular bodies may be classified based on force spectroscopy, such as acoustic force spectroscopy, in a holding space of a flow cell, wherein cellular bodies will detach from a functionalized wall of the holding space due to a force that is applied to the cellular bodies. Subsequent location tracking of the classified cellular bodies in the flow cell that move towards a sorting device allows individual sorting of the cellular bodies based on the detachment force or a parameter associated with the detachment force, which is a measure of how cellular bodies interact with cellular bodies and/or proteins of the functionalized wall space.

A functionalised wall surface as referred to herein may be provided with one or more primers. The primers may comprise one or more types of interaction moieties. In particular a functionalised wall surface may be provided with one or more substances comprising at least one of antibodies, peptides, biological tissue factors, biological tissue portions, bacteria, antigens, proteins, ligands, cells, tissues, viruses, (synthetic) drug compounds, lipid (bi)layers, fibronectin, cellulose, nucleic acids, RNA, small molecules, allosteric modulators, (bacterial) biofilms, “organ-on-a-chip”, etc., and/or specific atomic or molecular surface portions (e.g. a gold surface) to which at least part of the cellular bodies tends to adhere with preference relative to other surfaces.

Cellular bodies may make contact with specific parts of the functionalized wall surface. Here, the term contact may include any type of contact that cellular bodies can make with substances of the functionalized wall surface. For example, a cell (e.g. an effector cell) may contact and / or bind to another cell (e.g. a target cell) based on specific cell-cell interaction, based on e.g. that one or more proteins on the surface of one cell binds to the one or more proteins on the surface of another cell. In general any receptor or molecule on one cell may interact with and/or bind to another molecule on another cell and such interaction may be specific (e.g. a receptor may bind with exceptionally high affinity to only to certain types of antigens or ligands). Any such interaction may be based on a single receptor — ligand pair, multiple receptor — ligand pairs of the same type or multiple pairs of different types.

In an embodiment, the force applied to the cellular bodies may be a bulk acoustic force.

In an embodiment, the manipulation may further include: focusing detached first cells into a stream of single first cellular bodies. Focusing the detached first cellular bodies into a stream of single cellular bodies may aid in the ability to sort individual cellular bodies based on their specific detachment force. A detachment force may for example be determined based on a measured detachment time, i.e. a time instance at which a specific cellular body detaches. Each specific cellular body, part of a plurality of cellular bodies has its own specific detachment time. Alternatively, the detachment force may be determined based on a detachment time and/or a specific detachment location of a specific cellular body (e.g. in case the force application is not homogeneous over the holding space but depends on the location in the holding space / the location on the functionalized wall. As long as the detachment time and/or detachment location is known for a cellular body (e.g. based on processing of images obtained during the manipulation of the cellular body) and the position of the cellular body can be tracked to an area where cellular bodies are focused into a stream of cellular bodies, a cell cellular body with a known detachment time and / or location can be identified based on its position in the stream of single cellular bodies. A sorting device can then select the specific cellular bodies from the stream of single cellular bodies based on its position in the ordered stream and/or the known time delay between the cell passing a certain location in the flow cell and the time it arrives at the sorting device of the sorting device. Single cell sorting devices are known in the art, such as the sorting device based on hydrodynamic sorting described in the article by Choi et al, (mentioned in the background section above), or, for example, a micromechanical single cell sorting devices based on MEMS technology as described in US9453787.

In an embodiment, the focusing may include guiding the detached first cellular bodies through a tapered focusing region of the flow cell or guiding the detached first cellular bodies through a hydrodynamic focusing region, preferably the hydrodynamic focusing region being formed by forming a laminar sheath flow along the edge of part of the flow cell or flow channel.

In an embodiment, the manipulating may further include: exposing one or more of the detached first cellular bodies to radiation of one or more predetermined wavelengths and determining one or more optical responses of the one or more detached first cellular bodies respectively; and, wherein the controlling of the sorting device is further based on the one or more optical responses.

In an embodiment, the processing may further include: determining for each detached first cellular body, a position at the functionalized wall at which detachment of the first cellular body occurred; determining the detachment force for each of the detached first cellular bodies based on the location and a force correction map of the holding space, the force correction map containing information for determining the detachment force as a function of the location in the holding space. The force correction map may be obtained from a separate force calibration experiment and may be specific for the flow cell or holding space.

In an embodiment, at least part of the first cellular bodies may be labelled first cellular bodies, preferably the labelling being based on an optically responsive molecule such as a fluorescent molecule, and wherein at least part of the images are captured using a fluorescent imaging system.

In an embodiment, the flow cell may include at least a first flow channel comprising the holding space, the first flow channel being connected to the sorting device.

In an embodiment, the flow cell may include a first flow channel and a second flow channel, the second flow channel crossing the first flow channel at a cross-section, the cross-section defining a part of the holding space which is configured as an acoustically active area and the sorting device being connected to the second flow channel.

In an embodiment, the first cellular bodies may be provided into the holding space via the first flow channel and wherein the detached first cellular bodies are transported towards the sorting device via the second flow channel.

In an embodiment, the sorting device may be configured to receive detached first cellular bodies and to move each of the detached first cellular bodies into one of a plurality of output channels based on the detachment force. In an embodiment, the sorting device may use a hydrodynamic force to move a first cellular body in one of the plurality of output channels. In another embodiment, the sorting device may use a micromechanical valve to move a first cellular body in one of the plurality of output channels.

In an embodiment, the functionalized wall may comprise second cellular bodies, wherein when the first cellular bodies are provided into the holding space, at least part of the first cellular bodies will contact at least part of the second cellular bodies, preferably the first cellular bodies being effector cells and the second cellular bodies being target cells; or, the second cellular bodies being effector cells and the first cellular bodies being target cells.

In an embodiment, the target and/or effector cells may include at least one of: Lymphocytes, monocytic cells, granulocytes, T cells, natural killer cells, B-Cells, CAR-T cells, dendritic cells, Jurkat cells, bacterial cells, red blood cells, macrophages, TCR Tg T-cells, OT-I / OT-II cells, splenocytes, thymocytes, BM derived hematopoietic stem cells, TILs, tissue derived macrophages, innate lymphoid cells; and/or, wherein the second cells include at least one of: tumor cells, stem cells, epithelial cells, B16 melanoma, fibroblasts, endothelial cells, HEK293, HeLa, 3T3, MEFs, HuVECs, microglia, neuronal cells.

In another aspect, the invention may relate to a module for sorting cellular bodies based on images of cellular bodies in a flow cell connected to a sorting device, the module comprising a computer readable storage medium having computer readable program code embodied therewith, and a processor, preferably a microprocessor, coupled to the computer readable storage medium, wherein responsive to executing the computer readable program code, the processor is configured to perform executable operations comprising: receiving images representing manipulation of first cellular bodies in a holding space of a flow cell, the flow cell including or being connected to a sorting device, the manipulation including: providing the first cellular bodies in the holding space to allow at least part of the first cells to contact a functionalized wall of the holding space; applying a force, preferably an acoustic force, to the contacted first cellular bodies in a direction away from the functionalized wall for detaching at least part of the first cells; and, transporting the detached cellular bodies to the sorting device for individually sorting the detached cellular bodies; processing the sequence of images during the manipulation of the first cells and controlling the sorting device based on the image processing, the processing and controlling including: detecting detachments of first cellular bodies in the images during the application of the force; determining for each detected detached first cellular bodies a detachment force; tracking the location of detected detached first cellular bodies during the transport of the detached cellular bodies to the sorting device; and, sorting the detached cellular bodies by controlling the sorting device based on the detachment force.

In a further aspect, the invention may relate to a system for cell sorting comprising: a flow cell comprising a holding space for cellular bodies; a cell sorting device connected to the flow cell; a force generator for applying a force to the cellular bodies; an imaging system capturing images of the cellular bodies in the flow cell; an image processing system for processing the captured images; a controller for controlling the flow cell and the cell sorting device; and, a computer readable storage medium having computer readable program code embodied therewith, and a processor, preferably a microprocessor, coupled to the computer readable storage medium, wherein responsive to executing the computer readable program code, the processor is configured to perform executable operations comprising: receiving images representing manipulation of first cellular bodies in a holding space of a flow cell, the flow cell including or being connected to a sorting device, the manipulation including: providing the first cellular bodies in the holding space to allow at least part of the first cellular bodies to contact a functionalized wall of the holding space; applying a force, preferably an acoustic force, to the contacted first cellular bodies in a direction away from the functionalized wall for detaching at least part of the first cells; and, transporting the detached cells to the sorting device for individually sorting the detached cells; processing the sequence of images during the manipulation of the first cells and controlling the sorting device based on the image processing, the processing and controlling including: detecting detachments of first cells in the images during the application of the force; determining for each detected detached first cell a detachment force; tracking the location of detected detached first cells during the transport of the detached cells to the sorting device; and, sorting the detached cells by controlling the sorting device based on the detachment force.

The module and system described above may be configured to execute any of the method steps described in this application.

The invention may also relate to a computer program or suite of computer programs comprising at least one software code portion or a computer program product storing at least one software code portion, the software code portion, when run on a computer system, being configured for executing any of the method steps described above.

The invention may further relate to a non-transitory computer-readable storage medium storing at least one software code portion, the software code portion, when executed or processed by a computer, is configured to perform any of the method steps as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts a schematic of a force spectroscopy system according to an embodiment of the invention;

FIGS. 2A and 2B schematically depict a flow cell for a force spectroscopy system according to an embodiment of the invention;

FIG. 3 depicts a schematic of a typical experiment in a force spectroscopy system according to an embodiment of the invention;

FIG. 4 depicts two cell avidity curves determined using a force spectroscopy system according to an embodiment of the invention;

FIGS. 5A-5E depict a method of sorting single cells according to an embodiment of the invention;

FIG. 6 depicts a method of sorting single cells according to an embodiment of the invention;

FIGS. 7A-7C depict a method of determining an acoustic force map according to an embodiment of the invention;

FIG. 8 depicts an example of a force map;

FIGS. 9A and 9B schematically depict a cell sorting scheme according to an embodiment of the invention wherein at least part of the cells is labelled;

FIG. 10 depicts a sorting scheme according to an embodiment of the invention;

FIG. 11 depicts a sorting scheme according to another embodiment of the invention;

FIG. 12 depicts a sorting scheme according to yet another embodiment of the invention;

FIG. 13 is a block diagram illustrating an exemplary data processing system that may be used for executing methods and software products described in this application.

### DETAILED DESCRIPTION

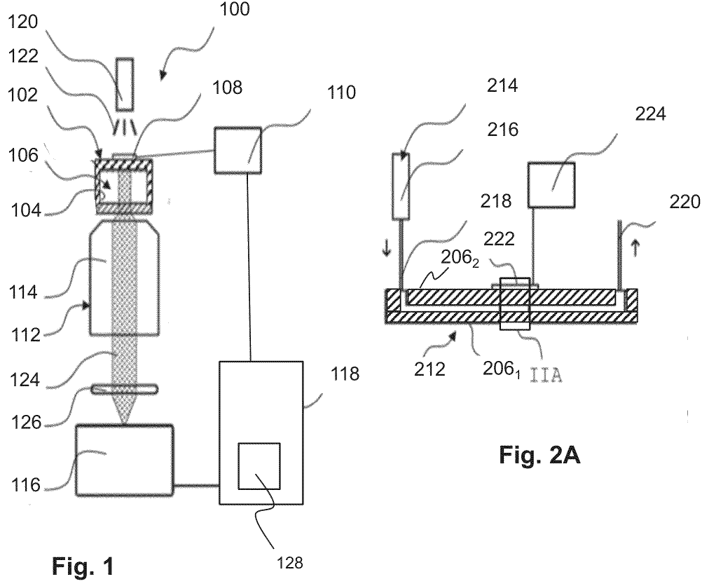

The embodiments below are intendent as non-limiting examples of the invention and although the embodiments are described with reference to cell sorting schemes, the embodiments are equality suitable for sorting any type of cellular body. FIG. 1 schematically depicts a force spectroscopy system according to an embodiment of the invention. The force spectroscopy system 100 may comprise a sample holder 102 comprising a holding space 104 for holding a sample 106 for holding cellular bodies in a fluid medium, e.g. a liquid or a gel. The holding space may be part of a flow cell (also referred to as a microfluidic cell). Different flow cell architectures may be used to manipulate, e.g. insert, hold and remove cells. The system may further comprise a force field generator 108, e.g. an acoustic wave generated based on a piezo element, connected to the sample holder 102 for generating a bulk acoustic wave in the holding space so that a force is exerted on cellular bodies that may be present in the holding space. The force field generator may be connected to a controller 110 so that the force exerted on the cellular bodies can be controlled.

The system of FIG. 1 may further comprise an imaging system for imaging the processes in the holding space. The imaging system may include a microscope 112 including optics, e.g. adjustable objective 114, and a camera 116 for capturing pictures, e.g. video frames, of the processes in the holding space. The imaging system may be connected to a computer 118 comprising a processor connected a memory comprising one or more software programs, which when executed, allow control of the different elements of the system.

The system may further comprise a light source 120 for illuminating the sample using any suitable optics (not shown) to provide a desired illumination intensity and intensity pattern, e.g. plane wave illumination, Köhler illumination, etc., known per se. Here, the light 122 emitted from the light source may be directed through the force field generator 108 to (the sample in) the sample holder 102 and sample light 124 from the sample is transmitted through the objective 114 and through an optional tube lens 126 and/or further optics (not shown) to the camera 116. The objective and the camera may be integrated. In an embodiment, two or more optical detection tools, e.g. with different magnifications or different imaging modalities (e.g. bright field, dark field, fluorescence, etc.), may be used simultaneously for detection of sample light, e.g. using a beam splitter.

In another embodiment, not shown but discussed in detail in WO2014/200341, the system may comprise a partially reflective reflector and light emitted from the light source is directed via the reflector through the objective and through the sample, and light from the sample is reflected back into the objective, passing through the partially reflective reflector and directed into a camera via optional intervening optics. Further embodiments may be apparent to the reader.

The sample light may comprise light affected by the sample (e.g. scattered and/or absorbed) and/or light emitted by one or more portions of the sample itself e.g. by chromophores/fluorophores attached to the cellular bodies.

Some optical elements in the system may be at least one of partly reflective, dichroic (having a wavelength specific reflectivity, e.g. having a high reflectivity for one wavelength and high transmissivity for another wavelength), polarisation selective and otherwise suitable for the shown setup. Further optical elements e.g. lenses, prisms, polarizers, diaphragms, reflectors etc. may be provided, e.g. to configure the system 100 for specific types of microscopy.

The sample holder 102 may be formed by a single piece of material with a channel inside, e.g. glass, injection moulded polymer, etc. (not shown) or by fixing different layers of suitable materials together more or less permanently, e.g. by welding, glass bond, gluing, taping, clamping, etc., such that a holding space 106 is formed in which the fluid sample is contained, at least during the duration of an experiment. While, the force spectrometry system of FIG. 1 includes an acoustic force generator, other ways of applying a pulling force on the cells may be used as well. For example, a force spectrometry system may use a centrifugal force generator for applying a force on the cells. Such force spectrometry system is e.g. known from US2016/0243560.

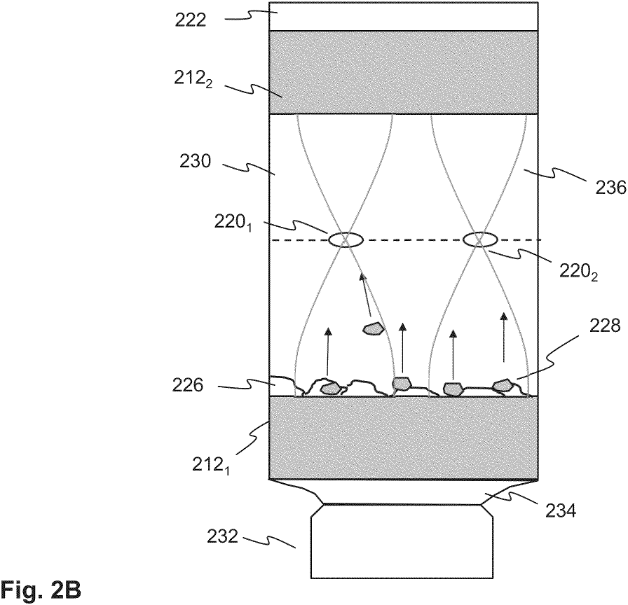

FIGS. 2A and 2B schematically depict cross-sectional views of a flow cell for a force spectroscopy system according to an embodiment of the invention. The sample holder 212 may comprise a first base part 206₁ that has a recess being, at least locally, U-shaped in cross section and a cover part 206₂ to cover and close (the recess in) the U-shaped part providing an enclosed holding space in cross section.

Further, the sample holder 212 may be connected to a fluid flow system 214 for introducing fluid and unbound cells into the holding space 206 of the sample holder and/or removing fluid from the holding space, e.g. for flowing fluid through the holding space (see arrows in FIG. 2A depicting the flow direction). The fluid flow system may be comprised in or part of a manipulation and/or control system including one or more of reservoirs 216, pumps, valves, and conduits 218 for introducing and/or removing one or more fluids, sequentially and/or simultaneously. The sample holder and the fluid flow system may include connectors, which may be arranged on any suitable location on the sample holder, for coupling/decoupling. In FIG. 2A only a single entry and single exit channel for the fluidics system are shown but as will be apparent from the descriptions below multiple entry and exit channels may be provided and/or separately controlled. Examples of flow cells with multiple channels are described hereunder in more detail. Additionally, the flow cell may include a cell sorting device that is configured to sort cells. The sample holder may further include a force field generator 222, e.g. an acoustic wave generator which may be implemented based on a (at least partially transparent) piezoelectric element connected to a controller 224.

FIG. 2B schematically depicts a cross-section of part of the sample holder including objective 232 that is positioned underneath part of a sample holder (a chip) wherein the sample holder may comprise a capping layer 212₁, a matching layer 212₂, a fluid medium 230 contained in the holding space formed by the capping and the matching layer, and part of a force generator 222, e.g. a piezo element. An immersion liquid 234 between the objective and the capping layer may be used to improve the optical numerical aperture (NA) of the imaging system. Application of an AC voltage to the piezo element at an appropriate frequency will generate a resonant bulk acoustic standing wave 236 in the sample holder. The standing wave will have nodes 220₁,₂ in the fluid layer at a certain height (this height may be referred to as the nodal plane here indicated with a dashed line) above the functionalized wall comprising target cells 226 attached to the wall of the sample holder and effector cells 228 that are bound to the target cells. Cells that have a positive acoustic contrast factor with respect to the fluid medium will experience a pulling force towards to the nodes.

One or more software programs that run on the computer 118 of the force spectroscopy system may be configured to control the camera, the force field generator, the fluidics system and the flow cell to conduct different experiments, including force spectroscopy and single cell sorting. In a typical experiment, cells, e.g. effector cells, may be flushed into the holding space of the flow cell and may interact, e.g. bind, with the target cells. This interaction can be probed by analysing the response of cells that are bound to target cells as a function of the force applied. Typically, the response of the cells is determined by analysing video frames that are captured by the camera. To that end, the computer may include an image processing module 128 comprising one or more image processing algorithms for analysing the response of the cells when they are manipulated in the flow cell using the force field generator. In particular, the image processing module may be configured to identify cells in the images and track locations of identified cells in subsequent images. This information may be used by the controller to control the flow in one or more channels for transporting detached cells, e.g. transporting cells in or out the holding space. Further, this information may be used by the controller to control other devices, such as e.g. a sorting device for sorting cells that detach due to the application of a force. The image analysis of the video frames and the use of the information derived from the image analysis are described hereunder in greater detail.

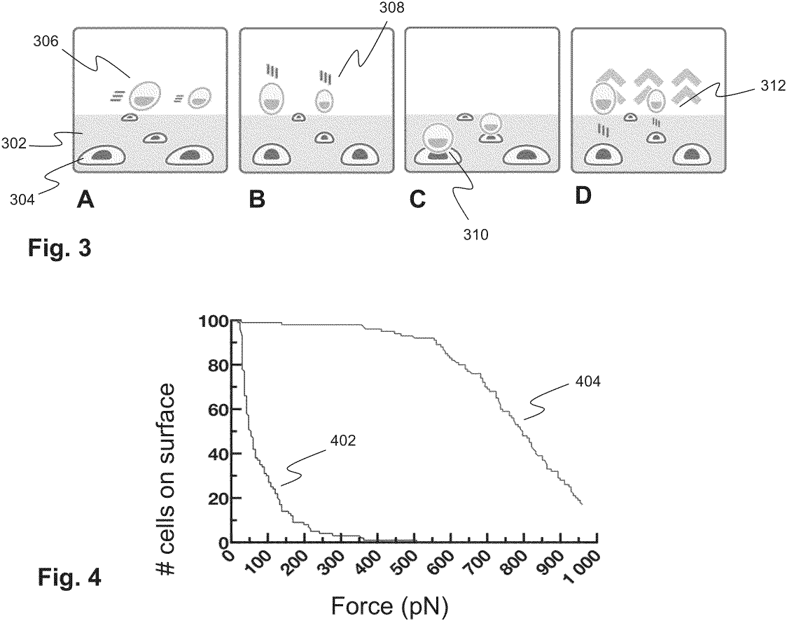

FIGS. 3A-3D depict schematics of manipulating cells in a holding space of a microfluidic cell comprising a functionalised wall surface to which target cells are attached. Such functionalized wall surface may form a cell assay. The microfluidic cell may be part of a force spectroscopy system as described with reference to FIGS. 1 and 2. The manipulation of the cells may be imaged from below or from the top using an imaging system as described with reference to FIG. 1. As depicted in FIG. 3A, the process may start with flushing a predetermined number of cells 306, e.g. effector cells, into the holding space of the microfluidic chip, comprising a functionalized wall 302 including target cells 304,. The introduction of the cells into the holding space may take a predetermined period of time, e.g. between 1 and 5 seconds. After flushing, the cells are allowed to settle onto the functionalized wall comprising the target cells (FIG. 3B). When the effector cells reach the functionalized wall, the cells may move around over the functionalized surface until they find a suitable target cell to bind to (surveillance) thus forming a bound effector - target cell pair 310 (FIG. 3C). The steps of effector cells settling onto the functionalized wall and binding to target cells may be referred to as the incubation phase. In a typical experiment, incubation may take up to 1-15 minutes or longer.

After the incubation phase, a pulling force may be applied to the effector cells that are bound to the target cells. The force has a direction away from the functionalized wall surface. Typically, a force ramp will be applied to the effector cells, so that if the force becomes larger than the binding force, effector cells will detach from the target cells and move away in the direction of the force (FIG. 3D). As the target cells are bound firmly to the functionalized wall, the force will “pull” the effector cells from the target cells and move the effector cells away from the functionalized wall surface. Pulling the effector cells from the target cells may be visible in the images and detected by the image processor based on a change of contrast, brightness, a movement of a group of pixels, etc. Such an event may be referred to as a detachment event. Based on further spatio-temporal behaviour of the effector cells, detachment events may be further filtered and/or classified as needed.

When the pulling force is larger than the binding force, the effector cell will detach from the target cell and move in a direction that depends on the applied force, which may have a component perpendicular to the functionalized wall (e.g. the z-direction) and two components in the plane of the functionalized wall (e.g. the x and y direction). The location in the image in which a detachment event may be detected can be determined on the basis of the images (video frames) which are captured during the experiment. The time at which cells detach may determine the force that is exerted on the effector cells. In a typical experiment, the force ramp may take between 2- 10 minutes.

Based on a measurement scheme as described with reference to FIG. 3, various parameters of the effector cells can be determined. For example, FIG. 4 depicts two cell avidity curves which may be determined by applying a force ramp to the functionalized wall surface and determining the number of attached cells as a function of the applied force. Based on the type of effector cells, cells may exhibit a low cell avidity curve 402 (weak binding forces between effector and target cells) or a high cell avidity curve 404 (strong binding forces between effector and target cells). These parameters may then be used in single cell sorting schemes that are described below in more detail.

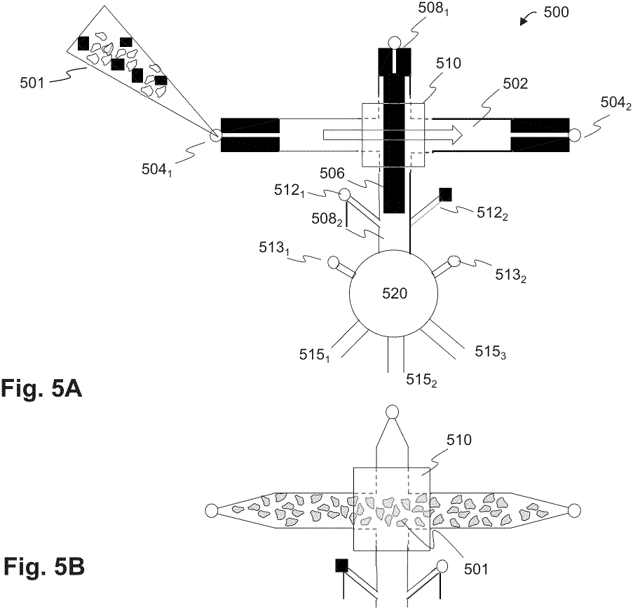

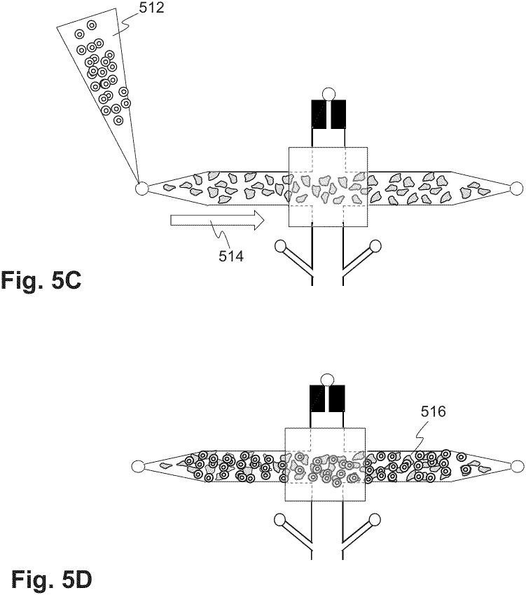

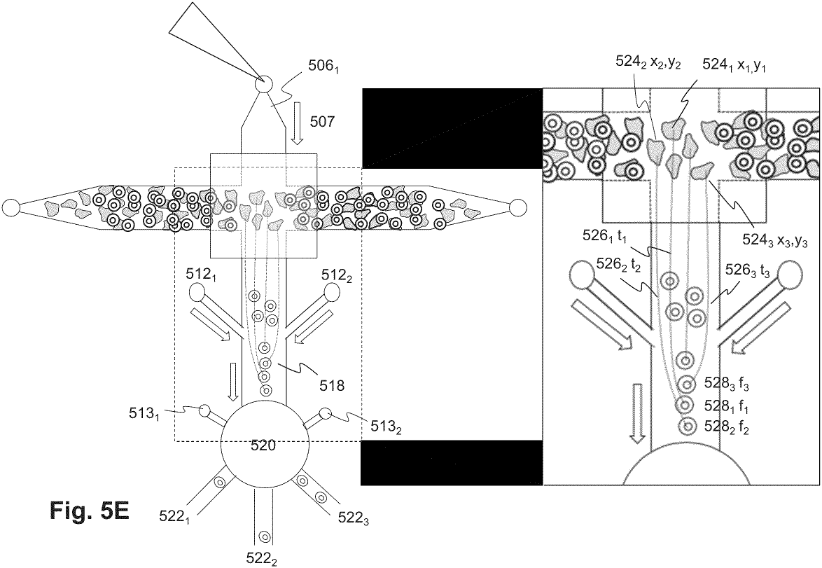

FIGS. 5A-5E depict a method of sorting single cells according to an embodiment of the invention. In particular, FIG. 5A depicts an example of a flow cell architecture that may be used to sort single cells based on a detachment force. As shown in the figure, the flow cell 500 may include a first channel 502 including an input and an output 504₁,₂ and a second channel 506 including an input and an output 508₁,₂. The output of the second channel may be connected to a cell sorting device 520. The first and second channel may cross each other at a cross-section, which may define an acoustically active part 510 of the holding space that as indicated by the square in the figure. This flow cell configuration may be used to execute a cell manipulation process which includes exerting a force to cells that are bound to a functionalized wall in a holding space of the first flow channel as e.g. described with reference to FIG. 3. Cells will detach from the functionalized wall surface at a certain detachment force. The cell manipulation process may include transporting the detached cells via the second flow channel to a sorting device 520 to sort the detached cells based on the detachment force or a parameter associated with the detachment force, such as the detachment time and/or detachment location . The manipulation of the cells in the flow cell may be captured by a camera and images may be processed and analysed in real-time and based on the information in the images, the flow cell and a sorting device (not shown attached to the flow cell may be controlled.

The output side of the second channel may include (or be connected to) a sorting device that is configured to sort cells on the single cell level. To that end, in some embodiments, the output side of the second channel may include means to focus detached cells originating from the holding space into a stream of single cells. For example, in an embodiment, the walls of the output side of the second channel may include flow outlets 512₁,₂, which may be controlled to realize a laminar sheath flow along the walls of the channel. As will be described hereunder in more detail, this laminar sheath flow may be used to manipulate and transport cells at single cell level. Alternatively, for example, a tapered channel could also be used to focus cells into a single line. The cell sorting device 520 may include means to move a cell into one of a plurality of reservoirs based on sorting criteria. For example, in case of a fluidic sorting device, the sorting device may include auxiliary flow inlets 513₁,₂ to move a cell into one of a plurality of reservoirs / exit channels 515₁,₂,₃. The article by Choi et al., Microfluidic deformability-activated sorting of single particles, Microsystems & Nanoengineering, 6, article number: 11 (2020), which hereby is incorporated by reference into this application, describes an example of such fluidic sorting device. By opening and closing valves that control the flow through the auxiliary flow inlets 513₁ and 513₂ cells can be forced to exit through exit channels 515₁, 515₂ or 515₃. If both 513₁ and 513₂ are open and the flux through these channels is similar the hydrodynamic flow causes cells to exit through exit channel 515₂. If 513₁ is closed and 513₂ is open, then the cells are pushed sideways to the left and exit through channel 515₁. If 513₁ is open and 513₂ is closed, then the cells are pushed to the right side and exit through channel 515₃.

The input and output of the first channel may be used to create a flow through the first channel allowing first cells 501, target cells, to enter the first channel and to settle onto a wall surface to which the target cells will attach. This situation is depicted in FIG. 5B, wherein the wall of the first channel forms a functionalized wall comprising the target cells. This way, the first channel will form a holding space for the target cells. As shown in the figure, at least part of the functionalized wall will be located within the acoustically active part of the holding space. Preferably the target cells are attached strongly enough to the wall surface to withstand the forces later used to detach the effector cells. A further step is depicted in FIG. 5C, wherein the input and output of the first channel are used to control a flow 514 through the channel allowing second cells, effector cells 512, to enter the first channel and to allow the effector cells to settle onto the functionalized wall of the first channel, including the acoustically active area part of the first channel. During the settling and / or incubation phase, free effector cells may attach to the target cells. Here settled cells on the wall surface are indicated as darker circular bodies. Thus a sample of effector cells bound to target cells can be prepared as depicted in FIG. 5D.

Thereafter, a force may be applied to the settled cells in the acoustically active part of the channel, so that at least some of the attached cells may detach in a way as explained with reference to FIGS. 1-3. The force applied to the cells may be gradually increased so that cells that are attached with different binding forces to the target cells may detach at different times. During or after detachment, a flow 507 through the second channel may be controlled to transport detached cells in a direction to the sorting device 520.

In this example, the second channel may be used to transport detached cells 518 in the direction of the sorting device 520, which is configured to sort each cell based on the detachment force or a parameter associated with the detachment force. In some embodiments, during transport towards the sorting device, cells may be manipulated into a stream of single cells so that at each time instance one single cells can be processed (sorted) by the sorting device. Another effect of manipulating the cells into a single stream is that the cells will have a predetermined order in the stream. Thus, once the order of the cells in such a stream has been established (for example by an image processing algorithm). The sorting device can sort cells based on a known ordering of the cells without the need for real-time (low-latency) interaction between the image processing algorithm and the sorting device.

During the settling of the effector cells, cells will attach to the functionalized wall space at different locations in the holding space. Further, cells may interact with the functionalized wall cell differently. Therefore, during the application of the force, cells will detach at different detachment times and at different detachment locations in the acoustically active area. This will result in cells 518 which detach at different times and different locations from the functionalized wall and which are transported via different trajectories via the second channel to the sorting device. This is schematically illustrated in the inset of FIG. 5E, showing trajectories t₁₋₃ 526₁₋₃ of detached cells moving through the second channel having different detach locations X₁₋₃ 524₁₋₃ and different detachment forces 528₁₋₃ f₁₋₃ (or different detach times).

In order to allow single cell sorting by the sorting device based on the detachment force, the detachment event should not only be detected, but the location of the detachment event and at least part of a trajectory of the detached cell moving through the holding space should be determined. To that end, the image processor should be able to detect detached cells and to track the location of detached cells.

A cell detection method for detecting detachment events may include a background correction method that allows removal of the background, i.e. the functionalized wall including the target cells, from the captured images so that foreground objects can better distinguished from the background. A filter, such as a Laplacian or Gaussian filter, may be applied to the background corrected images for blurring high frequency information in the image. The intensity of the pixels may be cropped to improve the black and white saturation. This step may be applied to ensure that the blobs in the processed image have sufficient contrast with respect to the background so that the blobs can be detected using a segmentation method. Further, a known thresholding operation, preferably a local thresholding operation, may be used to create a binary image, wherein blobs are formed by pixels having a first value and the background is formed by pixels having a second value. Blobs that contain “holes” due to irregularities or noise may be processed so that these holes are removed by filling each of these holes with pixel values. The location of the blobs in the image may be determined and the blob can be classified as a detached or attached cell. Optionally, the blobs may be classified as detached cell based on proximity, size, intensity, area, symmetry, etc.

During a force ramp up cells may be detected, localized and classified as detached or attached in images captured by a camera using the above-described method. Further, locations and trajectories of detected cells in subsequent images may be determined by linking locations for subsequent frames using a minimization algorithm, preferably a global minimization algorithm. For example, to efficiently link large numbers of detected cells in subsequent images a minimization of a cost function may be used as described in the article by Jaquaman et al, Robust single-particle tracking in live-cell time-lapse sequences, Nature Methods, Vol. 8, no. 8, August 2008, pp. 295-702, which is hereby incorporated by reference in this application. Alternatively, locations and trajectories of detected cells in subsequent images can be determined by following the location of detected particles in subsequent images. For example by updating the previous location by the new center of mass of the displaced blob or using a correlation to find the updated location, as described in the article by Cheezum et al, Quantitative comparison of algorithms for tracking single fluorescent particles Biophysical journal 81.4 2008, pp. 2378-2388. The trajectories will generate tracking paths from the active acoustic area towards the sorting device as illustrated in FIG. 5E. These tracking paths can be used to classify cells based on a detachment force or on parameters associated with detachment events This information may be stored by the computer and used to control the sorting device.

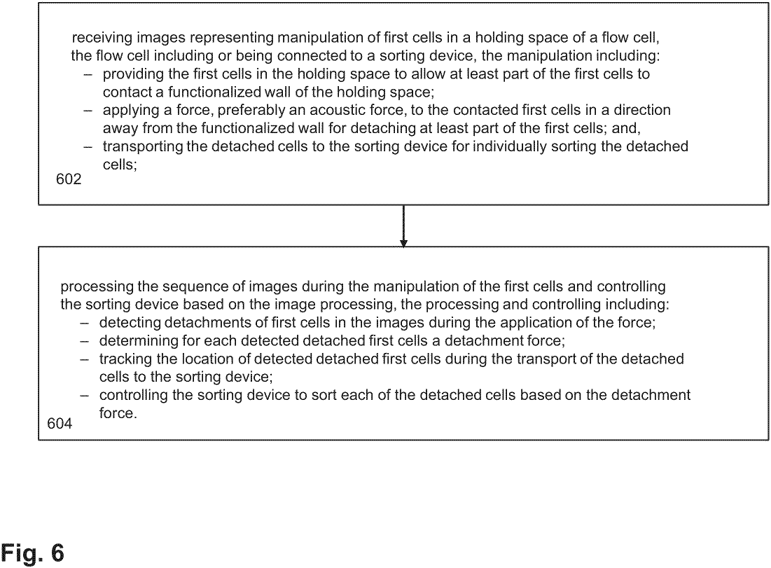

FIG. 6 depict a flow chart of a method of sorting single cells according to an embodiment of the invention. As shown in the figure, the method may be executed by a computer that controls a force spectroscopy system as described with reference to FIG. 3.

The method may include receiving images representing manipulation of first cells in a holding space of a flow cell (step 602), wherein the flow cell includes or is connected to a sorting device for sorting cells. The manipulation of the cells may include: providing the first cells in the holding space to allow at least part of the first cells to contact a functionalized wall of the holding space; applying a force, such as an acoustic force, to the contacted first cells in a direction away from the functionalized wall for detaching at least part of the first cells; and, transporting the detached cells to the sorting device for individually sorting the detached cells.

Further, the method may include processing the sequence of images during the manipulation of the first cells and controlling the sorting device based on the image processing (step 604), wherein the image processing and the controlling of the sorting device may include: detecting detachments of first cells in the images during the application of the force; determining for each of the detected detached first cells a detachment force; tracking the location of detected detached first cells in the images during the transport of the detached cells to the sorting device; and, controlling the sorting device to sort each of the detached cells based on the detachment force.

The sorting device is configured to individually sort detached cells based on at least the detachment force, for example the force at which an effector cell will detach from the functionalized wall, and possibly based on one or more further parameters, which may be determined during the manipulation of the cells in the flow cell. During the settling of the effector cells however, cells will attach to the functionalized wall space at different locations in the holding space. Hence, the length of the path (the trajectory) for detached cells to the sorting device will differ. Moreover, as will be described hereunder in greater detail, the force applied to cells may not be homogeneous throughout the holding space. This means that a force that an attached cell experiences may depend on the location in the holding space at which the cell is attached. Due to the differences in trajectories and forces, typically detached cells will not arrive at the sorting device in order of detached force.

To address these problems, when applying a force to the attached cells, the image processing module may detect cell detachment events. Each detected event may include detection of a detached cell and association of an identifier and coordinates x,y to each detected detached cell. Further, for each detached cell a detachment force may be determined as e.g. described with reference to FIGS. 3 and 4. This information may be stored in a memory of the computer. Thereafter, when the detached cells are transported to a sorting device and, in some embodiments, manipulated into a stream of single cells, the location of each detached cell is tracked. This way, for each detected detached cell a trajectory t through part of the flow cell, in this example a trajectory from the holding space towards the sorting device, can be determined. Thus, when a cell arrives at the sorting device, the computer knows at which time and at which location in the holding space the particle detached from the functionalized wall space, along which trajectory the cell was transported through the flow cell and the detachment force. The controller of the sorting device may use this information to determine how the cell should be classified and sorted accordingly.

Hence, based on the sorting method described above, single cells can be sorted based on a detachment force or a parameter associated with the detachment event, e.g. a detachment time and/or a detachment location, which was determined prior to the sorting process. This way, cells can be accurately sorted based the detachment force and, optionally, other parameters. The flow cell design in of FIG. 5, that includes a holding space formed at the position where flow channels cross each other is particular suitable for such sorting schemes. As shown in the figure, transporting detached cells out of the acoustically active area of the holding space via a clean contamination free second flow channel will not affect other parts of the functionalized wall surface in the first channel. This way, contamination of the second channel with cells or debris of other parts of the functionalized wall surface can be minimized.

It is submitted that the scheme depicted in FIG. 5 is only a non-limiting example to illustrate the advantages of the inventions. Many other variants exists without departing from the invention. For example, different flow cell designs, cell focussing means and sorting devices may be used for cell sorting schemes according to the invention. Examples will be described below.

As explained above, the holding space of a flow cell may have an inhomogeneous force distribution. In that case, to estimate the detachment force f of particle p, the system may use the particle detachment location x and a force map of the sample holder (f(t, x)) to determine a corrected detachment force which takes into account the inhomogeneities in the applied force.

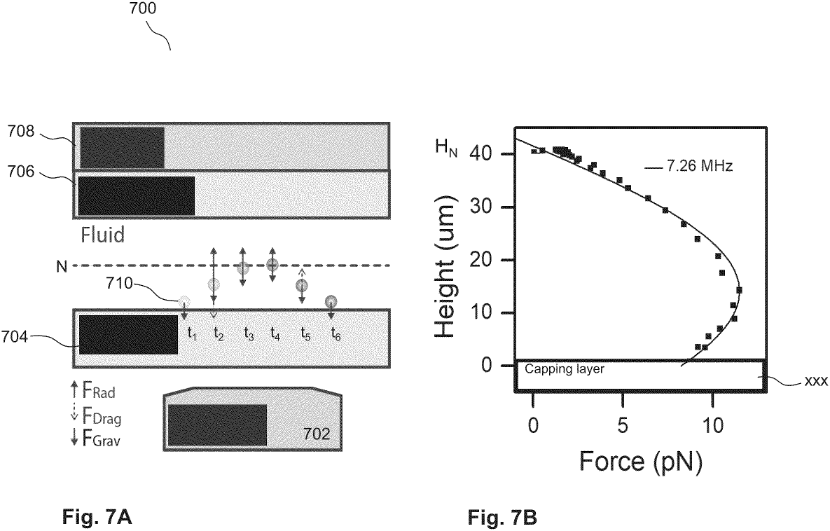

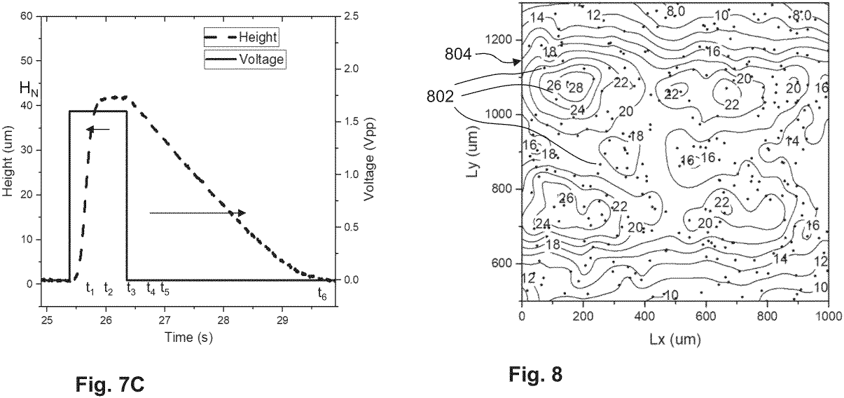

FIGS. 7A-7C depict a method of determining an acoustic force map according to an embodiment of the invention. It has been found that, in practice, the acoustic force may not be distributed evenly over the holding space but that local force variations may occur. For example, forces at the edges of the holding space may be smaller than forces in the centre. The figure illustrates a method to characterise such variations in force. FIG. 7A shows a cross-section of a sample holder 700 including a microscope objective 702 and a liquid filled holding space formed between a capping layer 704 and a matching layer 706 as e.g. described with reference to FIG. 2B. In the sample fluid a schematic of a test particle 710 moving subject to an acoustic force burst and forces in the direction perpendicular to the surface of the capping layer that act on the particle in (six) different time instances t₁... t₆. FIG. 7B shows the acoustic force as a function of height in the holding space between the surface of a wall of the sample holder (height = 0) and a node at height H _{N} during the acoustic burst and measured particle positions. FIG. 7C shows the temporal behavior of the driving signal burst Vpp (right axis) and the height of a particle in a sample holder (left axis).

At time instance t₁, no acoustic force is applied and the particle is at rest on the surface of the wall of the sample holder (marked capping) under the influence of the net downward forces of gravity and buoyancy F_{Grav} + F_{buoy}· Then at time instances t₂-t₃, an acoustic wave is generated in the sample holder providing a burst of acoustic force F_{Rad} driving the particle away from the surface towards the node (cf. FIG. 2B). When moving, the particle is now also subject to a drag force F_{Drag} counteracting the movement and F_{Rad} > (F _{Grav} + F_{buoy}). As long as the total force on the particle is positive [Fₜₒₜ = (F_{Grav} + F_{buoy}) + F_{Drag} + F_{Rad} > 0] the particle accelerates upward. The drag force F_{Drag} may be velocity dependent (assuming a spatially and temporally homogeneous sample fluid) and this quickly balances the other forces and the particle keeps moving at a constant velocity [Fₜₒₜ = (F _{Grav} + F_{buoy}) + F_{Drag} + F_{Rad} = 0] . Furthermore, the acoustic force F_{Rad} is height dependent, see FIG. 7B. At time instance t₄, the acoustic wave and hence the acoustic force is still present, but the particle has come to rest close to the node N; F _{Drag} = 0 and F _{Rad} = (F _{Grav} + F_{buoy}). At time instance t₅, the driving signal is stopped, so that the acoustic wave and hence the acoustic force are absent. The particle now falls back to the wall, counteracted by the drag force F_{Drag}. (F_{Grav} + F_{buoy}) > F_{Drag} and Fₜₒₜ = (F_{Grav} + F_{buoy}) + F_{Drag} < 0 (i.e.: downward). Finally, at time instance t₆ no acoustic force is applied and the particle is again at rest on the surface of the wall of the sample holder (the capping layer) under the influence of the net downward forces of gravity and buoyancy F _{Grav} + F_{buoy}.

The displacement of the particle may be detected via the microscope using known image capturing techniques including video and/or other time-resolved methods (e.g. methods such as described in WO 2014/200341). The spatiotemporal displacement properties of the particle through the sample fluid may be determined on the basis of the Navier-Stokes equations for the specific particle shape and size in combination with the properties of the fluid in the holding space. By detecting the displacement velocity of the particle, the acoustic force may be determined. Note that the same force determination may hold for any lateral displacement of the particle.

FIG. 7B shows that an acoustic model (solid line) for a force on the test particle may be fitted to the data. This allows one or more of interpolation, extrapolation and determination of the force at any specific height between the capping layer and the node. Using a repeating, possibly periodic, driving signal and possibly a small lateral force in one or two directions parallel to the surface and/or perpendicular to the direction of the acoustic force, an acoustic force at many different positions in the holding space distributed in one or two directions perpendicular to the acoustic force direction may be determined. The thus determined force values may be used to determine a force map of the active region of the holding space. Preferably, by probing many test particles in parallel a force map may be acquired more quickly.

An example of such force map is depicted in FIG. 8 wherein black dots show a large number of spatially distributed test particles 802 in a holding space (viewed from the top). In this example, a 1x PBS (Phosphate-buffered saline) solution supplemented with 0.02% w/v Pluronic f127 plus 0.02% w/v Casein solution was used as a sample fluid. The sample temperature was kept in a range of 25-37° C., and the particles were silica beads of ca 10.1 micrometer diameter (standard deviation 0.1 micrometer). Using a single driving signal burst / acoustic force burst as indicated with respect to FIGS. 7A-7C, the force on all test particles may be probed simultaneously, allowing establishing a force map exposing local force variations. Using a repeating, possibly periodic, driving signal more data may be obtained and the map may become even more accurate and/or detailed. Given sufficient homogeneity of the test particles, statistical information like averages, standard deviations of and/or local patterns and/or global patterns in the force distribution may be simply determined, otherwise averages and pattern may be (or: may have to be) calculated on the basis of results calculated independently for each of plural particles to be included in the determination of the average and/or the pattern.

The contour lines 804 in FIG. 8 indicate curves in the 2D plane for which the force on a test particle at a given power applied to the acoustic generator is the same. The numbers indicate relative forces on the test particles. A force map as shown in FIG. 8 has proven to be largely sample holder specific and largely constant over time and may be stored in a memory associated with a sample holder identifier and/or a chip identifier. Other parameters such as temperature and sample medium may also affect the force map and maybe also taken into account.

Thus, by tracking the particles or cells from the moment of detachment to the point at which they are sorted, the force map can be used to determine a corrected detachment force for each cell based on which the cells may be sorted. It is noted that for the sake of simplicity in the above discussion it is assumed all particles are similar in terms of acoustic contrast, size and shape such that for a given acoustic pressure gradient they experience the same force. In practice particle properties may differ and if known or measurable these properties can also be taken into account for determining a detachment force and/or for sorting the cells.

In an embodiment, cells are unlabeled cells. Hence, in that case, image detection and tracking of the cells in the flow cell may be based on images of the cells in the flow cells produced by brightfield microscopy. An example of such imaging detection and tracking process is described in pending Dutch application NL 2024155, with title Determining interactions between cells based on force spectroscopy, which is hereby incorporated by reference into this application. In another embodiment, some or all cells are labelled cells using a suitable fluorescent label. In that case, the image detection and tracking of the cells in the flow cell may be based on images of the cells in the flow cells produced by fluorescent microscopy.

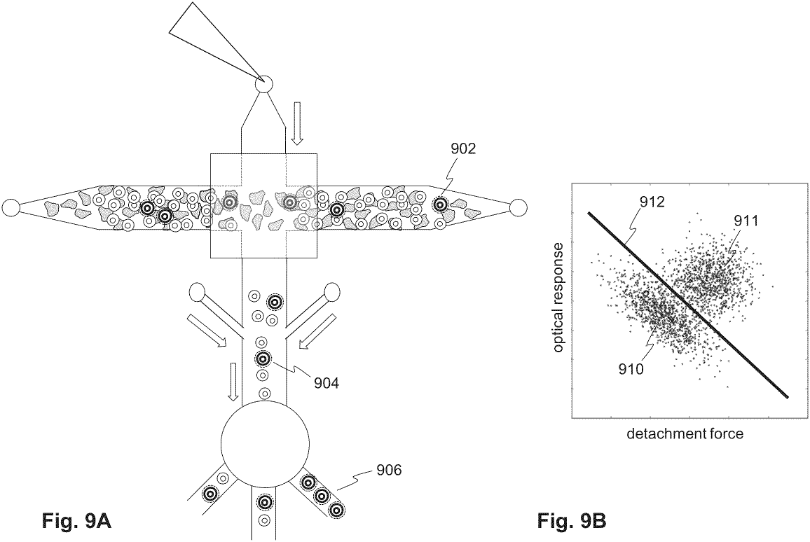

FIGS. 9A and 9B schematically depict a cell sorting scheme according to an embodiment of the invention wherein at least part of the cells are labelled. As shown in FIG. 9A, the sample in the first channel may be prepared with effector cells, that are labelled or at least partially labelled 902. During the force spectroscopy, detached effector cells may be tracked and sorted by the sorting device based on the detachment force and the optical response of the label. The imaging system may be a fluorescence imaging system, a multi-color imaging system, a multimodal imaging system, etc. and the labelled or unlabelled cells may have any combination of different optical characteristics. These optical characteristics may be further taken into account in controlling the sorting device and sorting of the particles into any number of desired fractions. In this example, for example, all cell which are fluorescent and have detachment forces over a certain threshold are sorted into the right exit channel of the sorting device while non-fluorescent particles and also particles with detachment forces below the set threshold are sorted into the other two exit channels. This way, cells can be separated based on two of more different parameters, including the detachment force (or a parameter associated with the detachment force) and e.g. the optical response of the cells as e.g. depicted in FIG. 9B. As can be seen from FIG. 9B sorting cells according to at least two parameters (2D sorting) may allow different clusters of cells do be differentiated that are not clearly differentiated based on either detachment force or optical response alone. In this example there are two clusters of cells (910 and 911 ) that can be identified in the 2D plot based on whether the data points belonging to the cells fall above or below the classification line 912.

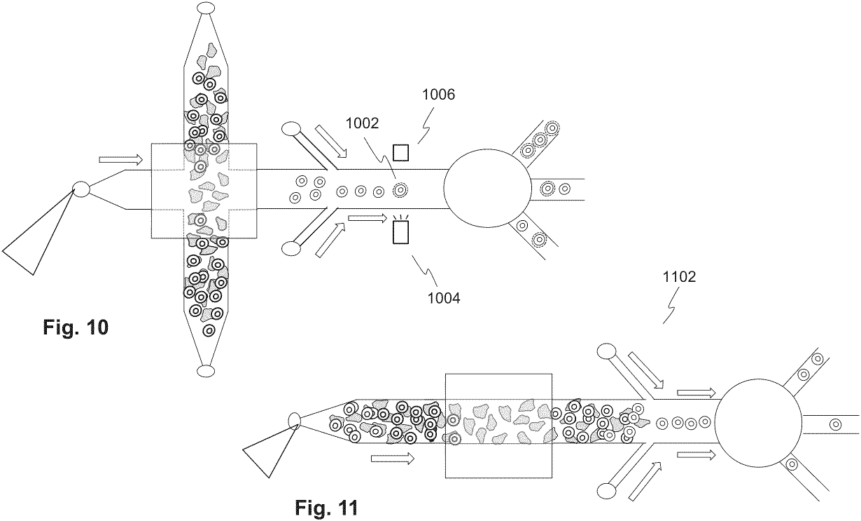

FIG. 10 illustrates a sorting scheme according to a further embodiment of the invention. In this embodiment, a flow cell system may be used that is similar to the one described with reference to FIG. 5. However, in this embodiment, after the focusing junction, but before the sorting device, a light source 1004 may be used to illuminate a tracked, detached cell 1002 in the channel and a detector 1006 (e.g. observing on the opposite side of the channel or under a 90 degree angle) may be configured to detect the transmitted, scattered and/or emitted light. The cells are tracked from the holding space at least to the focusing junction wherein the velocity of the cells in the channel may be set by setting the flow speed in the channel. The individually measured force parameters can now be linked to the optical parameters (such as for example fluorescence intensity) also without the need of complex fluorescence imaging in the holding space. It may be apparent to the reader that such a serial optical interrogation can be easily multiplexed to, for example, many different fluorescence colors and/or different scattering measurements. All these parameters can be considered by the controller to control the sorting device and to sort cells with similar properties into the same receiving container. This way multidimensional measurement and sorting can be achieved.

FIG. 11 depicts another variant wherein the flow cell is based on a linear flow cell that includes focussing and sorting functionality as described with reference to the embodiments in this application. Hence, in this embodiment, the flow cell does not comprise side channels.

FIG. 12 schematically depicts a cell sorting scheme according to another embodiment of the invention. In this embodiment, a single cell sorting method is used that does not necessarily require a focusing mechanism to manipulate the tracked cells into a single cell stream as e.g. described with reference to FIGS. 5A-5E. Alternative sorting methods may be implemented that are based on parallel instead of serial sorting methods and therefore do not require focusing of cells into a single line. For example, in an embodiment, optical tweezers may be used to pick specific cells from one location and move it to another where it can be further separated based on any standard microfluidic method. An example of such sorting method is described by Zhang and Liu in Optical tweezers for single cells Hu, Interface, J. R. Soc. Interface (2008) 5, 671-690).

The figure depicts a part of a flow cell comprising a stream of detached cells 1202 originating from a holding space 1204. The detached cells may be tracked and transported via a first laminar flow channel 1206 towards a sorting device comprising one or more optical trapping beams 1208 (drawn as two hourglass shaped dashed lines to indicate a focused laser beam). A controller may use the information on the position and detachment force of a predetermined detached cell and the measured detachment force to pick a predetermined cell from the first laminar flow channel and move it into another second (parallel) flow channel 1210. The boundary between the laminar flow channels is indicated as a dashed line.

The first channel may be a channel directly coming from the holding space carrying detached cells. The second channel may for example be a channel which is flushed with clean buffer solution. Thus, detached particles are tracked from the point (moment and location) of detachment to the sorting area where the trap can be controlled to pick out and sort particles based on any combination of detachment force and other parameters. This may be achieved using one fast moving optical trap, e.g. using acousto-optical deflectors, or alternatively using many parallel traps, for example using holographic optical tweezers also described by Zhang and Liu).

Yet another alternative technology that allows sorting of specific cells after they have been detached in the holding space relates to a sorting scheme described in US7612355. In this scheme, a light projection system and photoconductive materials in a microfluidic device may be used to apply forces on particles or cells using dielectrophoresis.

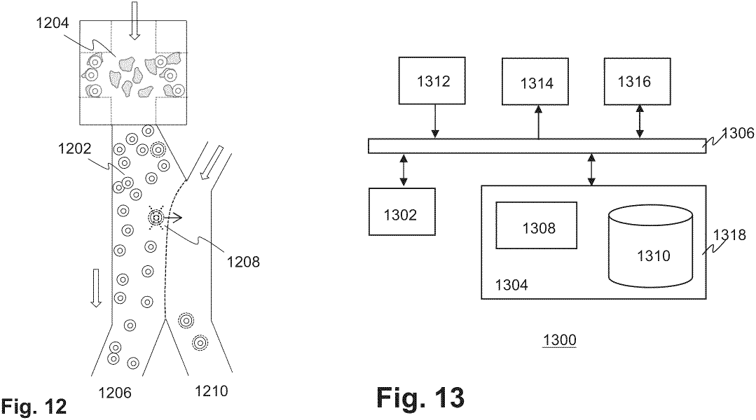

FIG. 13 is a block diagram illustrating exemplary data processing systems described in this disclosure. Data processing system 1300 may include at least one processor 1302 coupled to memory elements 1304 through a system bus 1306. As such, the data processing system may store program code within memory elements 1304. Further, processor 1302 may execute the program code accessed from memory elements 1304 via system bus 1306. In one aspect, data processing system may be implemented as a computer that is suitable for storing and/or executing program code. It should be appreciated, however, that data processing system 1300 may be implemented in the form of any system including a processor and memory that is capable of performing the functions described within this specification.

Memory elements 1304 may include one or more physical memory devices such as, for example, local memory 1308 and one or more bulk storage devices 1310. Local memory may refer to random access memory or other non-persistent memory device(s) generally used during actual execution of the program code. A bulk storage device may be implemented as a hard drive or other persistent data storage device. The processing system 1300 may also include one or more cache memories (not shown) that provide temporary storage of at least some program code in order to reduce the number of times program code must be retrieved from bulk storage device 1310 during execution.

Input/output (I/O) devices depicted as input device 1312 and output device 1314 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening I/O controllers. A network adapter 1316 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1300.

As pictured in FIG. 13, memory elements 1304 may store an application 1318. It should be appreciated that data processing system 1300 may further execute an operating system (not shown) that can facilitate execution of the application. Application, being implemented in the form of executable program code, can be executed by data processing system 1300, e.g., by processor 1302. Responsive to executing application, data processing system may be configured to perform one or more operations to be described herein in further detail.

In one aspect, for example, data processing system 1300 may represent a client data processing system. In that case, application 1318 may represent a client application that, when executed, configures data processing system 1300 to perform the various functions described herein with reference to a “client”. Examples of a client can include, but are not limited to, a personal computer, a portable computer, a mobile phone, or the like.

In another aspect, data processing system may represent a server. For example, data processing system may represent an (HTTP) server in which case application 1318, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for sorting cellular bodies comprising:
receiving images representing manipulation of first cellular bodies in a holding space of a flow cell, the flow cell including or being connected to a sorting device, the manipulation including:
providing the first cellular bodies in the holding space to allow at least part of the first cellular bodies to contact a functionalized wall of the holding space;
applying a force to the contacted first cellular bodies in a direction away from the functionalized wall for detaching at least part of the first cellular bodies; and,
transporting the detached cellular bodies to the sorting device for sorting the detached cellular bodies; and
processing images during the manipulation of the first cellular bodies and controlling the sorting device based on the image processing, the processing and controlling including:
detecting detachments of first cellular bodies in the images during the application of the force;
determining for detected detached first cellular body a detachment force;
tracking the location of detected detached first cellular bodies during the transport of the detached cellular bodies to the sorting device; and,
sorting the detached cellular bodies by controlling the sorting device based on the detachment force.

2. The method according to claim 1 wherein the manipulation further includes: focusing detached first cellular bodies into a stream of single first cellular bodies.

3. The method according to claim 2 wherein the focusing includes guiding the detached first cellular bodies through a tapered focusing region of the flow cell or guiding the detached first cellular bodies through a hydrodynamic focusing region .

4. The method according to claim 1, wherein the manipulating further includes: exposing one or more of the detached first cellular bodies to radiation of one or more predetermined wavelengths and determining one or more optical responses of the one or more detached first cellular bodies respectively; and, wherein the controlling of the sorting device is further based on the one or more optical responses.

5. The method according to claim 1 wherein the processing further includes:
determining for a detached first cellular body a position at the functionalized wall at which detachment of the first cellular body occurred; and
determining the detachment force for the detached first cellular body based on the location and a force correction map of the holding space, the force correction map comprising information for determining the detachment force as a function of the location in the holding space.

6. The method according to claim 1, wherein at least part of the first cellular bodies are labelled first cellular bodies, and wherein at least part of the images is captured using a fluorescent imaging system.

7. The method according to claim 1 wherein the flow cell includes at least a first flow channel comprising the holding space, the first flow channel being connected to the sorting device, wherein at least part of the first flow channel is configured as an acoustically active area.

8. The method according to claim 1 wherein the flow cell includes a first flow channel and a second flow channel, the second flow channel crossing the first flow channel at a cross-section, the cross-section defining a part of the holding space which is configured as an acoustically active area and the sorting device being connected to the second flow channel.

9. The method according to claim 8, wherein the first cellular bodies are provided into the holding space via the first flow channel and wherein the detached first cellular bodies are transported towards the sorting device via the second flow channel.

10. The method according to claim 1 wherein the sorting device is configured to receive detached first cellular bodies and to move the detached first cellular bodies into one of a plurality of output channels based on the detachment force.

11. The method according to claim 1 wherein the functionalized wall comprises second cellular bodies, wherein when the first cellular bodies are provided into the holding space, at least part of the first cellular bodies will contact to at least part of the second cellular bodies .

12. The method according to claim 1 wherein the sorting device is at least one of: a hydrodynamic sorting device, a micromechanical sorting device or a sorting device comprising one or more optical traps.

13. The method according to claim 1 wherein the tracking of the locations of the detached first cells includes linking locations of detected detached first cells in subsequent images based on a tracking algorithm .

14. A module for sorting cellular bodies based on images of cellular bodies in a flow cell connected to a sorting device, the module comprising a computer readable storage medium having computer readable program code embodied therewith, and a processor coupled to the computer readable storage medium, wherein responsive to executing the computer readable program code, the processor is configured to perform executable operations comprising:
receiving images representing manipulation of first cellular bodies in a holding space of a flow cell, the flow cell including or being connected to a sorting device, the manipulation including:
providing the first cellular bodies in the holding space to allow at least part of the first cellular bodies to contact a functionalized wall of the holding space;
applying a force to the contacted first cellular bodies in a direction away from the functionalized wall for detaching at least part of the first cellular bodies; and,
transporting the detached cellular bodies to the sorting device for sorting the detached cellular bodies; and
processing images during the manipulation of the first cellular bodies and controlling the sorting device based on the image processing, the processing and controlling including:
detecting detachments of first cellular bodies in the images during the application of the force;
determining for detected detached first cellular body a detachment force;
tracking the location of detected detached first cellular bodies during the transport of the detached cellular bodies to the sorting device; and,
sorting the detached cellular bodies by controlling the sorting device based on the detachment force.

15. A system for sorting cellular bodies comprising:
a flow cell comprising a holding space for cellular bodies;
a sorting device connected to the flow cell or included in the flow cell;
a force generator for applying a force to the cellular bodies;
an imaging system capturing images of the cellular bodies in the flow cell;
an image processing system for processing the captured images;
a controller for controlling the flow cell and the sorting device; and,
a computer readable storage medium having computer readable program code embodied therewith, and a processor, coupled to the computer readable storage medium, wherein responsive to executing the computer readable program code, the processor is configured to perform executable operations comprising:
receiving images representing manipulation of first cellular bodies in a holding space of a flow cell, the flow cell including or being connected to a sorting device, the manipulation including:
providing the first cellular bodies in the holding space to allow at least part of the first cellular bodies to contact a functionalized wall of the holding space;
applying a force, to the contacted first cellular bodies in a direction away from the functionalized wall for detaching at least part of the first cellular bodies; and,
transporting the detached cellular bodies to the sorting device for sorting the detached cellular bodies; and
processing images during the manipulation of the first cellular bodies and controlling the sorting device based on the image processing, the processing and controlling including:
detecting detachments of first cellular bodies in the images during the application of the force;
determining for detected detached first cellular body a detachment force;
tracking the location of detected detached first cellular bodies during the transport of the detached cellular bodies to the sorting device; and,
sorting the detached cellular bodies by controlling the sorting device based on the detachment force.

16. A computer program or suite of computer programs comprising at least one software code portion or a computer program product storing at least one software code portion, the software code portion, when run on a computer system, being configured for executing the method steps according to claim 1.

17. The method of claim 3 wherein the hydrodynamic focusing region is formed by forming a laminar sheath flow along the edge of part of the flow cell.

18. The method of claim 6 wherein the labelling is based on at least one optically responsive molecule such as a fluorescent molecule.

19. The method of claim 11 wherein the first cellular bodies are effector cellular bodies and the second cellular bodies are target cellular bodies.

20. The method of claim 11 wherein the second cellular bodies are effector cellular bodies and the first cellular bodies are target cellular bodies.
